(19) United States
(12) Patent Application Publication
(10) Pub. No.: US 2021/0213463 A1
(43) Pub. Date: Jul. 15, 2021

(54) A SCREEN BOWL DECANTER CENTRIFUGE

(71) Applicant: Thomas Broadbent & Sons, Limited, Yorkshire (GB)

(72) Inventors: Andrew John SELWAY, Mirfield (GB); Nicholas Robert FROHLICH, Lebanon, OH (US); Nigel Patterson HAIGH, Holmfirth (GB)

(21) Appl. No.: 15/733,881

(22) PCT Filed: May 30, 2019
(86) PCT No.: PCT/GB2019/051481

§ 371 Date: Nov. 30, 2020

Related U.S. Application Data
(60) Provisional application No. 62/678,566, filed on May 31, 2018.

(30) Foreign Application Priority Data
Jul. 12, 2018 (CA) 3011152

(51) Int. Cl. B04B 3/04; B04B 1/08; B04B 1/20

(52) U.S. Cl. CPC B04B 3/04; B04B 1/20; B04B 1/08

(57) ABSTRACT

A screen bowl decanter centrifuge comprises a horizontally rotatable bowl (10) within which a scroll conveyor (46, 60) is coaxially mounted for rotation at a slightly different speed for conveying solids, deposited by centrifugal action on the internal surface of the bowl, towards a solids discharge end of the bowl, the other end of the bowl having a liquids outlet (28). The bowl (10) has an imperforate frustoconical portion (18), which converges towards the solids discharge end and provides a sloping ramp up which solids are drawn by the conveyor out of the liquid pool contained in the bowl, and a perforate screen portion (20) downstream of the imperforate frustoconical portion (18) in the direction of solids discharge for assisting dewatering of the solids. The perforate screen portion (20) comprises a first portion (22) downstream of the imperforate frustoconical portion (18), inclined at a first angle with respect to the rotational axis (A-A) of the bowl, and a second, divergent portion (24), considered in the direction of solids discharge, downstream of the first portion (22) and inclined at a second angle with respect to the rotational axis of the bowl. The scroll conveyor (46, 60) is located adjacent to both the imperforate portion (18) and the perforate screen portion (20) of the bowl.

The present invention relates to screen bowl decanter centrifuges.

One known screen bowl decanter centrifuge comprises a horizontally rotatable bowl within which a scroll conveyor is coaxially journalled for rotation at a slightly different speed for conveying solids, deposited by centrifugal action on the internal surface of the bowl, towards a solids discharge end of the bowl, the other end of the bowl having a liquids outlet. The majority of the bowl is usually cylindrical but at the solids discharge end there is a frusto- conical portion which converges towards the discharge end and provides a sloping ramp up which solids are drawn by the conveyor out of the liquid pool contained in the bowl. The ramp thus provides a drying area for such solids conveyed out of the liquid pool. In known screen bowl centrifuges, the frusto-conical ramp section is supplemented by a coaxially disposed, cylindrical screen section located downstream of the ramp in the conveying direction.

Thus, sedimentation is carried out in the cylindrical/conical section of the bowl but then the solids conveyed out of the liquid pool are conveyed over the screen section thereby improving the dewatering action.

The latter machine configuration is particularly useful with materials which drain easily. Consequently they find frequent application in the dewatering of coal and other minerals. In such applications, however, it is highly desirable to use very large machines in view of the quantity of product to be treated. A severe limitation on the design and manufacture of very large centrifugal machines is, however, the torque requirement, i.e. the torque required to drive the conveyor. A number of factors contribute to this torque requirement but the frictional effect of the product being conveyed over the screen provides a major component. If a reduction in the conveying torque could be attained, this would have the dual benefit of removing some of the design limitations affecting the gearbox associated with the conveyor drive, thus reducing its size and cost, and of giving a very useful reduction in the total power consumption.

An alternative construction of screen bowl decanter centrifuge, which attempts to reduce the conveyor torque, is disclosed in our earlier application GB 2 064 997 A. This document discloses a screen bowl decanter centrifuge in which the screen section of the bowl is of divergent conical form, considered in the direction towards the solids outlet end.

The stated advantage of this arrangement is that the provision of a divergent screen section significantly reduces the conveying torque requirements since the centrifugal forces on the solids assist their passage along the screen section. However, the angle of the divergent section should be less than the frictional angle of the solids product with which the centrifuge is being used so as to ensure that the solids do not simply flow outwardly over the divergent surfaces with negligible travel time. In the case of coal, for example, the friction angle is typically in the range of about 20° to 25°, for example about 22°.

An additional stated advantage is that the larger diameter of the screen section encountered by the solids as they are conveyed towards the outlet end of the bowl provides a higher G factor and thus improves dewatering. At the same time, the diverging nature of the screen section means that, as the solids move towards the discharge and, an increasingly large screen area becomes available so that there is consequently a progressive reduction in the height of the solids pile above the screen, which further improves the drainage facility.

However, one important aspect in assessing the performance of a decanter is its power consumption. A significant part of the electrical power consumed by the decanter is used to accelerate the liquid and solids mixture fed to the decanter up to the high rotational speed of the decanter solid bowl. For a given bowl rotational speed (rpm) the energy lost when material (solids or liquids) is discharged from the decanter increases as the square of the radius (i.e. distance from the centre line of the rotating assembly) at which the material is discharged. The kinetic energy loss is:

Mass discharged×(Radius of discharge×2π×rpm/60)²

The present invention has been devised with the above in mind.

In accordance with a first aspect of the present invention, there is provided a screen bowl decanter centrifuge of the type comprising a horizontally rotatable bowl within which a scroll conveyor is coaxially mounted for rotation at a slightly different speed for conveying solids, deposited by centrifugal action on the internal surface of the bowl, towards a solids discharge end of the bowl, the other end of the bowl having a liquids outlet, the bowl having an imperforate frustoconical portion, which converges towards the solids discharge end and provides a sloping ramp up which solids are drawn by the conveyor out of the liquid pool contained in the bowl, and a perforate screen portion downstream of the imperforate frustoconical portion in the direction of solids discharge for assisting dewatering of the solids, wherein the perforate screen portion comprises a first portion downstream of the imperforate frustoconical portion, inclined at a first angle with respect to the rotational axis of the bowl, and a second, divergent portion, considered in the direction of solids discharge, downstream of the first portion and inclined at a second angle with respect to the rotational axis of the bowl, and wherein the scroll conveyor is located adjacent to both the imperforate portion and the perforate screen portion of the bowl.

The majority of the liquid that is discharged through the screen section occurs during the initial part of its travel over the screen. If the screen is initially inclined only at a shallow angle (e.g. 0° such that the first perforate screen portion is cylindrical) followed by a divergent section then this initial loss of liquid results in a lower energy loss than that of a fully divergent screen without an upstream section of shallow (e.g. zero) inclination. This is because the average radius over which the liquid is discharged is smaller for the combination of the present invention.

The scroll conveyor preferably extends for substantially the whole length of the rotatable bowl.

The first perforate screen portion may be slightly converging. For example, the angle of inclination of the first perforate screen portion may be from 0° to 5° with respect to the rotational axis of the bowl.

The first perforate screen portion may be slightly divergent. For example, the angle of inclination of the first perforate screen portion may be from 0° to 5° with respect to the rotational axis of the bowl.

In a preferred embodiment, the first perforate screen portion is cylindrical.

In a preferred embodiment, the perforate cylindrical screen portion is located adjacent to the imperforate frusto-conical bowl portion.

In a preferred embodiment, the perforate divergent frusto-conical screen portion is located adjacent to the perforate cylindrical screen portion.

Tthe angle of the second, divergent permeable screen section may be less than the frictional angle of the solids product with which the centrifuge is being used. This ensures that the solids do not simply flow outwardly over the divergent surfaces with negligible travel time.

Alternatively, the angle of the second, divergent permeable screen section may be greater than the frictional angle of the solids product with which the centrifuge is being used.

By way of example only, a specific embodiment of the present invention will now be described with reference to the accompanying drawings, in which:

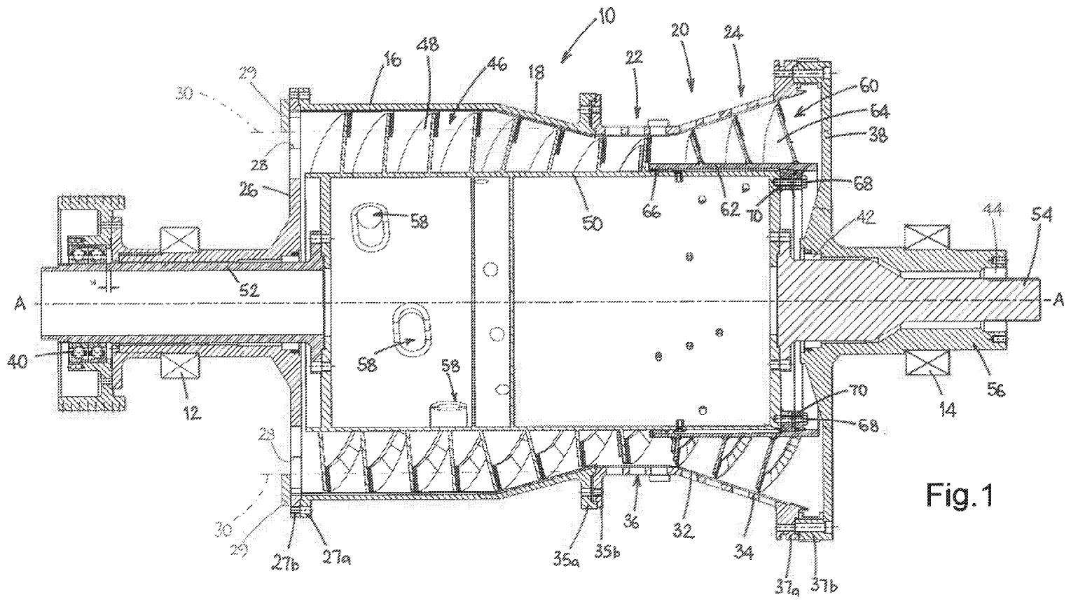

FIG. 1 is a longitudinal cross-section through embodiment of screen bowl decanter centrifuge in accordance with the present invention; and

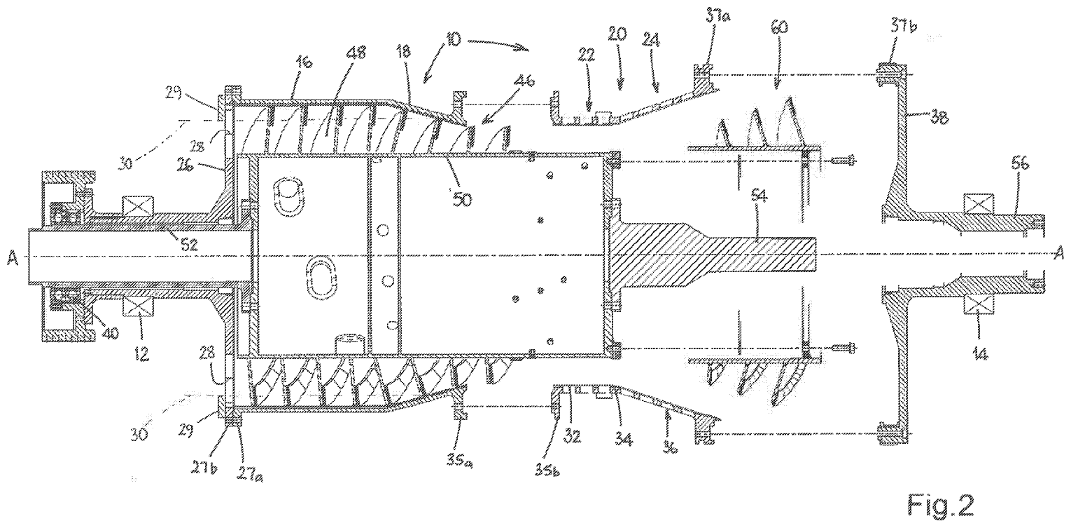

FIG. 2 is an exploded view of the cross-section of FIG. 1.

The centrifuge illustrated in the drawings includes a bowl 10 which is journalled in bearings 12, 14 for rotation about a horizontal axis A-A. The bowl 10 includes an imperforate first cylindrical portion 16 of relatively large diameter, an imperforate frusto-conical portion 18 and a screen portion 20. The screen portion 20 comprises a first cylindrical screen portion 22 of the same internal diameter as the minimum diameter of the frusto-conical bowl portion 18 and a divergent frusto-conical screen portion 24 contiguous with the cylindrical screen portion 22. The left-hand end (as viewed in the drawings) of the cylindrical wall portion 16 is closed by a radial wall 26 which is secured to the outer end of the cylindrical portion 16 by bolts (not shown) passing through aligned apertures in cooperating lugs 27a, 27b on the cylindrical portion 16 and the wall 26. The wall 26 contains one or more apertures 28 serving to define a weir for determining the depth of an annular liquids pool which is established in the bowl. The level of this pool, indicated in FIG. 1 by a chain line 30, is determined by the radial position of adjustable plates 29 extending across the apertures and bolted to the wall 26, and it will be noted that the liquid pool encounters the imperforate frusto-conical portion 18 about two-thirds along its length.

The screen portion 20 is located immediately downstream of the imperforate frusto-conical portion 18 and is formed from a known thin screen member 32 supported by a support frame 34 having much larger apertures 36 permitting unrestricted passage of liquids passing through the screen 32. The right-hand end (as seen in the drawings) of the screen portion 20 is closed by a further radial wall 38. The inner, abutting ends of the imperforate frusto-conical portion 18 and the cylindrical screen portion 22 are secured together by means of bolts (not shown) passing through aligned apertures in cooperating lugs 35a, 35b on the imperforate frusto-conical portion 18 and the cylindrical screen portion 22, and the radial wall 38 is secured to the outer end of the screen portion 20 by bolts (not shown) passing through aligned apertures in cooperating lugs 37a, 37b on the screen portion 20 and the wall 38.

Coaxially journalled within the bowl 10 in bearings 40, 42, 44 is a first scroll conveyor 46 comprising a helical flight 48 extending outwardly from the exterior surface of a hollow drum 50. The left-hand end (as seen in the drawings) of the hollow drum 50 is attached to a hollow shaft 52 mounted in the bearings 40 and the opposite end of the drum is attached to a solid shaft 54 which is rotatably mounted by means of the bearings 40, 42 in a complementarily- shaped sleeve 56 extending outwardly from the radial wall 38 which closes off the screen portion 20. The hollow shaft 52 permits the slurry to be processed to be introduced into the interior of the drum 50. The drum 15 has a plurality of apertures 58 between adjacent turns of the conveyor flight 46 for introducing the slurry into the imperforate cylindrical and frusto-conical portions 16, 18 of the bowl.

As can be seen from the drawings, the first scroll conveyor 46 extends partially into the cylindrical screen portion 22, and is contiguous with a second scroll conveyor 60 in the region of the cylindrical screen portion 22 and the divergent frusto-conical screen portion 24. The second scroll conveyor 60 is coaxially aligned with the first scroll conveyor 46 and comprises a sleeve 62 which is a slidable fit over the end of the hollow drum 50 and a helical flight 64 extending outwardly from the outer surface of the sleeve 62. The second scroll conveyor 60 is located radially by sliding its sleeve 62 over the outer surface of a band 66 welded to the outer surface of the drum 50 at the end of the first helical flight 68 and is secured to the first scroll conveyor at the longitudinally outermost end of the sleeve 62 by means of securing bolts 68 passing through radially inwardly extending securing lugs 70 located towards the longitudinally outer end of the sleeve 62 and being threadedly received in the end wall of the hollow drum 50 of the first scroll conveyor 46.

In use, in a known manner the bowl 10 is rotated by means of a motor (not shown) and a gearbox (also not shown) rotates the first and second scroll conveyors 46, 60 in the same direction as the bowl 10 but at a slightly different speed from the bowl 10. Slurry to be separated is introduced into the hollow drum 50 through the hollow shaft 52 and makes its way to the inner surface of the bowl 10 via the apertures 58 in the cylindrical wall of the drum.

In the known manner, the rotational speed of the bowl 10 is chosen so that the slurry is forced centrifugally against the interior surface of the bowl 10. The solids within the slurry settle on the wall of the bowl and, since the first scroll conveyor 46 rotates at a slightly different speed to the bowl 10, the separated solids are scrolled along the wall, towards and along the imperforate frusto-conical wall conical portion 18. The separated liquids are discharged out of the apertures 28 in the radial wall 26.

The scrolling of the solids by the first scroll conveyor 46 displaces the solids longitudinally onto the screen portion 20. The solids firstly encounter the cylindrical screen portion 22 and then the divergent frusto-conical screen portion 24, where the continuing rotation causes further amounts of liquid to be discharged radially, allowing the increasingly dry solids to be scrolled to the right (as shown in the drawings), where they can be discharged through solids discharge ports (not visible in the drawings) in a known manner.

The angle of the divergent section should be less than the frictional angle of the solids product with which the centrifuge is being used so as to ensure that the solids do not simply flow outwardly over the divergent surfaces with negligible travel time. In the case of coal, for example, the friction angle is typically in the range of about 20° to 25°, for example about 22°.

A significant part of the electrical power consumed by the decanter centrifuge is used to accelerate the liquid and solids mixture fed to the decanter up to the high rotational speed of the imperforate cylindrical and frusto-conical portions of the bowl. For a given bowl rotational speed (rpm), the energy lost when material (solids or liquids) is discharged from the decanter increases as the square of the radius (i.e. the distance from the centre line A-A of the rotating assembly) at which the material is discharged. Kinetic energy loss EL is given by the following equation:

E_{L}=(Mass discharged)×(Radius of discharge×2π×rpm/60)²

Therefore, the majority of the liquid discharged through the screen section occurs during the initial part of its travel over the screen. By providing a screen which is initially cylindrical followed by a divergent section (in the scrolling direction of the solids), then the initial loss of liquid results in a lower liquid energy loss than that of a solely divergent screen without a cylindrical section, because the average radius over which the liquid is discharged is smaller for the cylindrical/divergent screen combination.

In addition, the present invention achieves the advantages of lower torque requirements associated with a divergent screen.

The invention is not restricted to the details of the foregoing embodiment.

For example, although the screen portion 22 adjacent to the imperforate frusto-conical portion 18 has been described as cylindrical, it may be slightly converging (e.g. inclined from 0° to 5° with respect to the rotational axis of the bowl) or may be slightly divergent (e.g. inclined from 0° to 5° with respect to the rotational axis of the bowl).

1. A screen bowl decanter centrifuge of the type comprising a horizontally rotatable bowl within which a scroll conveyor is coaxially mounted for rotation at a slightly different speed for conveying solids, deposited by centrifugal action on the internal surface of the bowl, towards a solids discharge end of the bowl, the other end of the bowl having a liquids outlet, the bowl having an imperforate frustoconical portion, which converges towards the solids discharge end and provides a sloping ramp up which solids are drawn by the conveyor out of the liquid pool contained in the bowl, and a perforate screen portion downstream of the imperforate frustoconical portion in the direction of solids discharge for assisting dewatering of the solids, wherein the perforate screen portion comprises a first portion downstream of the imperforate frustoconical portion, inclined at a first angle with respect to the rotational axis of the bowl, and a second, divergent portion, considered in the direction of solids discharge, downstream of the first portion and inclined at a second angle with respect to the rotational axis of the bowl, and wherein the scroll conveyor is located adjacent to both the imperforate portion and the perforate screen portion of the bowl.

2. A screen bowl decanter centrifuge as claimed in claim 1, wherein the scroll conveyor extends for substantially the whole length of the rotatable bowl.

3. A screen bowl decanter centrifuge as claimed in claim 1, wherein the first perforate screen portion is slightly converging.

4. A screen bowl decanter centrifuge as claimed in claim 3, wherein the angle of inclination of the first perforate screen portion is from 0° to 5° with respect to the rotational axis of the bowl.

5. A screen bowl decanter centrifuge as claimed in claim 1, wherein the first perforate screen portion is slightly divergent.

6. A screen bowl decanter centrifuge as claimed in claim 5, wherein the angle of inclination of the first perforate screen portion is from 0° to 5° with respect to the rotational axis of the bowl.

7. A screen bowl decanter centrifuge as claimed in claim 1, wherein the first perforate screen portion is cylindrical.

8. A screen bowl decanter centrifuge as claimed in claim 1, wherein the first perforate screen portion is located adjacent to the imperforate frusto-conical bowl portion.

9. A screen bowl decanter centrifuge as claimed in claim 1, wherein
the second perforate divergent frusto-conical screen portion is located adjacent to the first perforate cylindrical screen portion.

10. A screen bowl decanter centrifuge as claimed in claim 1, wherein the angle of the second, divergent permeable screen section is less than the frictional angle of the solids product with which the centrifuge is being used.

11. A screen bowl decanter centrifuge as claimed in claim 1, wherein the angle of the second, divergent permeable screen section is greater than the frictional angle of the solids product with which the centrifuge is being used.
